(19) United States
(12) Patent Application Publication
(10) Pub. No.: US 2008/0143995 A1
(43) Pub. Date: Jun. 19, 2008

(54) MOVING APPARATUS

(75) Inventors: Yoshihisa Hiyama, Utsunomiya-shi (JP); Yoshihiro Hirata, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/952,023

(22) Filed: Dec. 6, 2007

(30) Foreign Application Priority Data
Dec. 19, 2006 (JP) 2006-341812

(51) Int. Cl. G03B 27/58

(52) U.S. Cl. 355/72

(57) ABSTRACT

A moving apparatus includes a movable body movable in at least one direction; an electromagnet configured to drive a movable body and including a coil; an electromagnet control system configured to perform feedback control of the electromagnet on the basis of a command value input to the electromagnet control system; and a thrust correction unit configured to calculate a correction coefficient corresponding to a thrust error of the electromagnet and correct the command value by multiplying the command value by the correction coefficient or by adding the correction coefficient to the command value.

### BACKGROUND OF THE INVENTION

1. Field of the Invention

The present invention relates to a moving apparatus that moves a movable body at a high speed. The moving apparatus according to the present invention is suitable for use in an exposure apparatus used in a semiconductor manufacturing process, in particular, a projection exposure apparatus in which a reticle pattern is projected and transferred onto a silicon wafer. More specifically, the moving apparatus according to the present invention is suitable for use as a reticle stage on which a reticle is mounted and a wafer stage for moving the silicon wafer with respect to a projection optical system in the step of projecting the reticle pattern onto the wafer.

2. Description of the Related Art

Apparatuses called a stepper and a scanner are commonly known as exposure apparatuses used for manufacturing semiconductor devices. In the stepper, a semiconductor wafer is placed on a stage device and is moved stepwise under a projection lens. A pattern image formed on a reticle is reduced and projected onto the wafer by the projection lens. Thus, the pattern image is successively projected at a plurality of positions on the wafer. In the scanner, a wafer placed on a wafer stage and a reticle placed on a reticle stage are moved relative to a projection lens. Slit-shaped exposure light is irradiated during scanning so that the reticle pattern is projected onto the wafer. The stepper and the scanner provide high resolution and superposition precision, and are therefore most commonly used as exposure apparatuses.

A throughput is an index of performance of the exposure apparatuses. The throughput shows the number of wafers that can be processed in a unit time. To achieve a high throughput, the wafer stage and the reticle stage must be moved at a high speed. A low-heat, high-speed stage system having a known structure includes a coarse-motion stage and a fine-motion stage. The coarse-motion stage is accelerated and decelerated by a coarse-motion linear motor, and the fine-motion stage is accelerated and decelerated by electromagnets that do not generate high heat. Positioning of the fine-motion stage is performed by a fine-motion linear motor. Such a structure is described in, for example, Japanese Patent Laid-Open No. 2000-106344. Accordingly, heat generated by the fine-motion linear motor is reduced and the influence of heat is suppressed. The influence of heat includes, for example, thermal expansion and deformation of the reticle, the wafer, and the stages holding the reticle and the wafer, fluctuation of light paths of laser interferometers for measuring the positions of the reticle and the wafer, changes in the light path lengths of the laser interferometers, etc.

In the above-described known exposure apparatus, the heat generated by the fine-motion linear motor cannot be sufficiently reduced and the influence of heat cannot be eliminated. This is because thrust is generated by the electromagnets in response to only a drive current calculated from command information, and therefore includes errors caused by disturbance. Accordingly, a desired thrust obtained by correcting the errors with the fine-motion linear motor.

### SUMMARY OF THE INVENTION

The present invention is directed to a moving apparatus that is free from the above-described disadvantages.

According to an aspect of the present invention, a moving apparatus is provided which includes an electromagnet having a coil for moving a movable body that is movable in at least one direction and an electromagnet control system configured to perform feedback control of the electromagnet on a basis of an input command value. The moving apparatus also includes a thrust correction unit. The thrust correction unit detects an error between a thrust to be generated by the electromagnet in response to the command value and a thrust generated by the electromagnet by the feedback control and corrects the error.

According to an embodiment of the present invention, a thrust correction unit measures a distance between an electromagnet and a movable body, calculates a correction value for a drive current applied to a coil on the basis of the result of the measurement, and reduces a thrust error by multiplying a command value by the correction coefficient or by adding the correction coefficient to the command value.

Alternatively, the thrust correction unit measures a thrust generated between the electromagnet and the movable body, calculates a correction value for a drive current applied to a coil on the basis of the result of the measurement, and reduces a thrust error by multiplying a command value by the correction coefficient or by adding the correction coefficient to the command value.

Further features and aspects of the present invention will become apparent from the following description of exemplary embodiments with reference to the attached drawings.

### BRIEF DESCRIPTION OF THE DRAWINGS

FIG. 1 is a diagram illustrating an example stage device according to an embodiment of the present invention.

FIG. 2 is a diagram illustrating example electromagnets shown in FIG. 1.

FIG. 3 illustrates an example of an electromagnet control system for controlling the electromagnets shown in FIG. 1.

FIG. 4 illustrates another example of an electromagnet control system for controlling the electromagnets shown in FIG. 1.

FIG. 5 is a diagram illustrating an example stage device according to another embodiment of the present invention.

FIG. 6 is a diagram illustrating an example exposure apparatus to which the present invention is applied.

FIG. 7 is a flowchart of an example device manufacturing process using the exposure apparatus.

### DESCRIPTION OF THE EMBODIMENTS

Various embodiments, features and aspects of the present invention will be described in detail with reference to the accompanying drawings.

### First Exemplary Embodiment

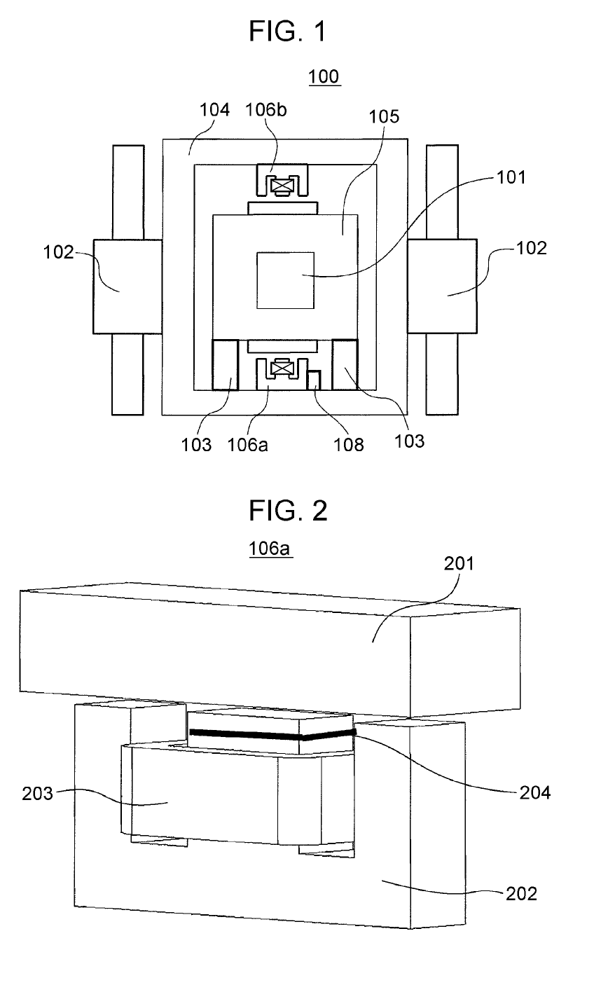

FIG. 1 shows the structure of an example stage device using a moving apparatus according to a first embodiment of the present invention. The stage device functions as a reticle stage of an exposure apparatus, such as a semiconductor exposure apparatus. However, the stage device according to the present embodiment can also be used as a wafer stage of the exposure apparatus. Alternatively, the stage device can also be installed in other kinds of apparatuses.

Referring to FIG. 1, a reticle stage (movable body) 100 holds a reticle 101 and serves to convey and position the reticle 101 at an exposure position. In the reticle stage 100, a coarse-motion stage 104 is driven by coarse-motion linear motors 102. A fine-motion stage 105 is supported without being in contact with a coarse-motion stage 104, and is driven by fine-motion linear motors 103 and electromagnets 106a and 106b. The electromagnets 106a and 106b generate an acceleration force for driving the fine-motion stage 105. The fine-motion linear motors 103 perform precise positioning of the reticle 101, in other words, precise positioning of the fine-motion stage 105. Therefore, it is not necessary for the fine-motion linear motors 103 to generate the acceleration force for driving the fine-motion stage 105, and generation of heat from the fine-motion linear motors 103 can be suppressed.

In the apparatus shown in FIG. 1, a gap sensor 108 is disposed between the electromagnet 106a and the fine-motion stage 105 as a measuring unit for measuring a distance (gap) between the electromagnet 106a and the fine-motion stage 105. Thus, a mechanism for measuring the distance between the electromagnet 106a and the fine-motion stage 105 is provided. Alternatively, position measurement devices, such as laser interferometers, disposed outside the reticle stage 100 can be used to measure the positions of the coarse-motion stage 104 and the fine-motion stage 105. In such a case, the distance between the electromagnet 106a and the fine-motion stage 105 can be calculated on the basis of the measurement results of the position measurement devices.

FIG. 2 illustrates the detailed structure of the electromagnet 106a. The electromagnet 106a includes a yoke 202 that is slightly spaced from a magnetic plate 201 so that a force can be transmitted therebetween without contact. The magnetic plate 201 constitutes a part of the fine-motion stage 105. An attraction force is generated between the yoke 202 and the magnetic plate 201 by applying a current to a driving coil 203 attached to the main body (yoke 202) of the electromagnet 106a. A drive amplifier 306 supplies the current to the coil 203. An induced voltage is measured by a search coil 204 wound around the yoke 202 of the electromagnet 106a.

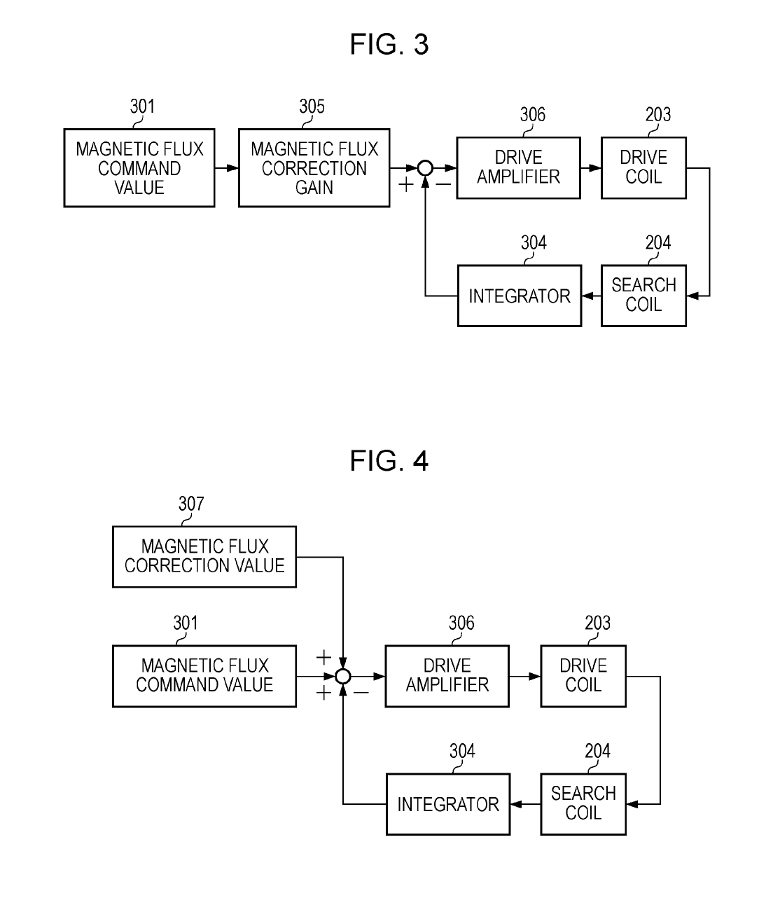

FIG. 3 shows an electromagnet control system. A force generated by the electromagnet 106a is proportional to the square of magnetic flux between the electromagnet 106a (yoke 202) and the magnetic plate 201. The electromagnet control system receives a command value (hereinafter referred to as a magnetic-flux command value) 301 corresponding to an acceleration/deceleration force from a main controller (not shown). The magnetic-flux command value is in the dimensions of square root of the absolute value of the acceleration/deceleration force, that is, in the dimensions of magnetic flux.

An induced voltage measured by the search coil 204 is integrated by an integrator 304, and is obtained in the dimensions of magnetic flux (that is, in the dimensions of current). The amount of magnetic flux for obtaining a desired thrust is calculated on the basis of the output from the integrator 304. The distance between the electromagnet 106a and the magnetic plate 201 is measured. If the distance between the electromagnet 106a and the magnetic plate 201 changes, the magnetic-flux command value is multiplied by a correction gain (magnetic-flux correction coefficient) 305 corresponding to the change in the distance. The correction gain can be set in advance. According to the present invention, the electromagnet control system includes a thrust correction unit having the above-described structure.

For example, thrust errors corresponding to distance changes are measured in advance to determine thrust correction coefficients for obtaining a desired thrust. The thrust is proportional to the square of the magnetic flux. Therefore, the magnetic-flux correction coefficient to be input for the magnetic flux command can be determined by a linear function approximating the relationship between the square root of the thrust correction coefficient and the distance change. The order of the function can also be two or more. Alternatively, a linear function or a function of second or higher order approximating the relationship between the thrust correction coefficient and the distance change can be used, and the square root of the thrust correction coefficient determined by the function can be used as the magnetic-flux correction coefficient.

According to the present embodiment, the error of thrust generated by the electromagnet is detected (or predicted) by detecting the distance between the electromagnet and the magnetic plate (movable body).

### Second Exemplary Embodiment

FIG. 4 illustrates another example of an electromagnet control system. Similar to the electromagnet control system shown in FIG. 3, in the electromagnet control system shown in FIG. 4, the distance between the electromagnet 106a and the magnetic plate 201 is measured. However, in this example, if the distance between the electromagnet 106a and the magnetic plate 201 changes, a correction value 307 corresponding to the distance change is added to the magnetic-flux command value. The correction value can be set in advance. More specifically, thrust errors corresponding to distance changes are measured in advance to determine correction values for obtaining a desired thrust.

In the first and second embodiments, the error between the thrust generated by the electromagnet 106a for accelerating the fine-motion stage 105 and the desired thrust is corrected by measuring the distance between the electromagnet 106a and the magnetic plate 201 and determining a correction value for correcting the command value 301. Therefore, heat generated by the fine-motion linear motors 103 for precise positioning can be reduced and the influence of heat can be suppressed.

### Third Exemplary Embodiment

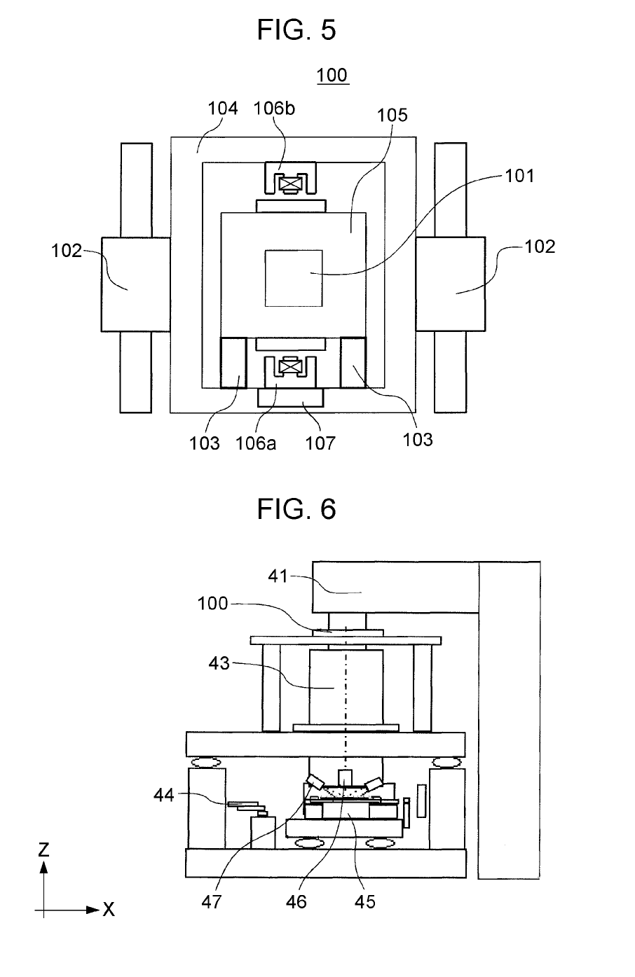

FIG. 5 shows a modification of the stage device shown in FIG. 1. In FIG. 5, a force measurement device 107, such as a strain gauge, is provided at a connecting portion between the electromagnet 106a and the coarse-motion stage 104. The error between the thrust generated by the electromagnet 106a and the desired thrust is measured using the force measurement device 107, and the correction value 305 or 307 for the magnetic-flux command value 301 is calculated on the basis of the result of the measurement. The thrust is corrected by multiplying the magnetic-flux command value by the correction value or by adding the correction value to the magnetic-flux command value.

The force measurement device 107 can also be provided at the connecting portion between the magnetic plate 201 and the fine-motion stage 105.

In the present embodiment, the thrust generated by the electromagnet 106a for accelerating the fine-motion stage 105 is directly measured, and the correction value is determined on the basis of the result of the measurement. Therefore, heat generated by the linear motor that performs precise positioning can be reduced and the influence of heat can be suppressed.

### Fourth Exemplary Embodiment

An example of an exposure apparatus including a positioning/moving apparatus according to the present invention will be described below. Referring to FIG. 6, the exposure apparatus includes an illumination unit 41, a reticle stage 100 on which a reticle is placed, a reduction projection lens 43, and a wafer stage 45 on which a wafer is placed. A wafer-conveying robot 44 is provided for conveying the wafer to the wafer stage 45 and removing the wafer from the wafer stage 45. In addition, an alignment scope 46 is provided for positioning the reticle and the wafer with each other and a focus scope 47 is provided for positioning the wafer at an in-focus position of the reduction projection lens 43. The exposure apparatus projects a circuit pattern on the reticle onto the wafer by exposure using a step-and-repeat method or a step-and-scan method.

The illumination unit 41 illuminates the reticle having the circuit pattern, and includes a light source unit and an illumination optical system. The light source unit includes a laser, such as an ArF excimer laser with a wavelength of about 193 nm, a KrF excimer laser with a wavelength of about 248 nm, and an F₂ excimer laser with a wavelength of about 153 nm, as a light source. The laser is not limited to excimer lasers, and YAG lasers and other kinds of lasers can also be used. The number of lasers is also not limited. When a laser is used as a light source, a beam-shaping optical system for shaping a parallel light beam from the light source into a desired beam form and an incoherent optical system for converting a coherent laser beam into an incoherent laser beam can be used. The light source that can be used in the light source unit is not limited to lasers, and lamps, such as one or more mercury lamps and xenon lamps, can also be used.

The illumination optical system is an optical system for illuminating the mask, and includes a lens, a mirror, a light integrator, a diaphragm, etc.

The reduction projection lens 43 can be an optical system including only a plurality of lens elements, an optical system including a plurality of lens elements and at least one concave mirror (catadioptric optical system), an optical system including a plurality of lens elements and at least one diffractive optical element, such as a kinoform, or an optical system including only a plurality of mirrors.

The reticle stage 100 and the wafer stage 45 can be moved by, for example, linear motors. When the step-and-scan method is used, the reticle stage 100 and the wafer stage 45 are moved in synchronization with each other. In addition, an additional actuator is provided on at least one of the wafer stage 45 and the reticle stage 100 to position the reticle pattern with respect to the wafer. The above-described exposure apparatus can be used for manufacturing a semiconductor device, such as a semiconductor integrated circuit, a micromachine, and a device like a thin film magnetic head that has a micropattern.

### Fifth Exemplary Embodiment

Processes for manufacturing small devices (for example, semiconductor chips such as ICs and LSIs, liquid crystal panels, CCDs, thin-film magnetic heads, and micromachines) using the above-described exposure apparatus will now be described.

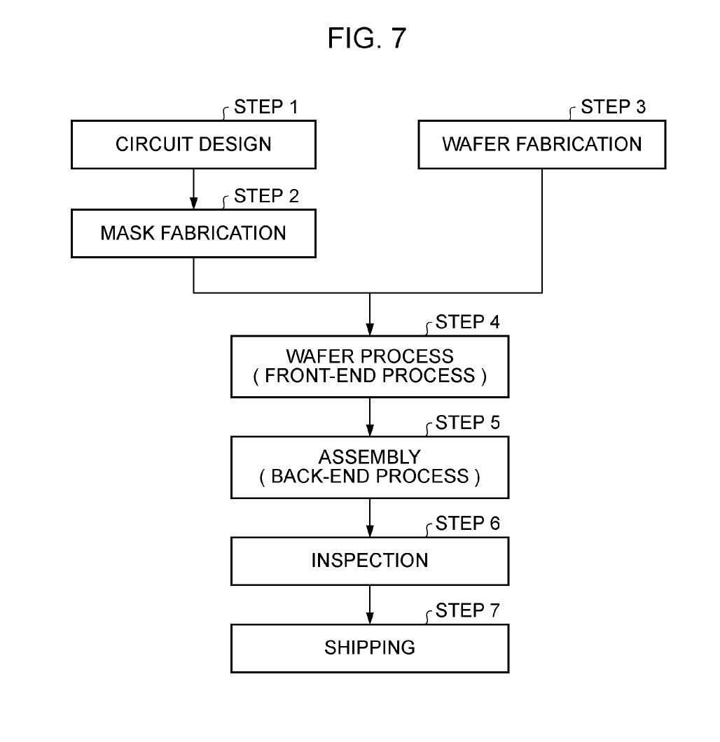

FIG. 7 is a flowchart showing processes for manufacturing semiconductor devices. In Step 1 (circuit design), a circuit of semiconductor devices is designed. In Step 2 (mask fabrication), a mask (also called an original or reticle) is fabricated in the designed circuit pattern.

In Step 3 (wafer fabrication), a wafer (also called a substrate) is formed of a material such as silicon. In Step 4 (wafer process), called a front-end process, actual circuits are formed on the wafer by lithography with the exposure apparatus in which the mask set and the wafer.

In Step 5 (assembly), called a back-end process, semiconductor chips are formed from the wafer obtained in Step 4. This process includes an assembly process (dicing and bonding) and a packaging process (chip sealing). In Step 6 (inspection), the semiconductor devices obtained in Step 5 are tested for, for example, operation and durability. The semiconductor chips are thus completed through the above processes, and are then shipped (Step 7).

The wafer process performed in Step 4 includes an oxidation step of oxidizing the surface of the wafer; a CVD step of forming an insulating film on the surface of the wafer; an electrode forming step of forming electrodes on the wafer by vapor deposition; an ion implantation step of implanting ions into the wafer; a resist processing step of applying a photosensitive agent to the wafer; an exposure step of exposing the wafer subjected to the resist processing step using the mask having the circuit pattern; a development step of developing the exposed wafer; an etching step of removing parts other than the developed resist image; and a resist removal step of moving the resist, which becomes unnecessary after etching. By repeating these steps, a multi-layer circuit pattern is formed on the wafer.

According to the present invention, the electromagnet generates an accurate thrust on the basis of the command value. Therefore, in the case in which the electromagnet is used together with a linear motor for precisely positioning the stage, which functions as a movable body, the thrust generated by the linear motor can be minimized by accelerating or decelerating the stage using the electromagnet. As a result, the heat generated by the linear motor that performs precise positioning can be reduced and the influence of heat can be suppressed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-341812 filed Dec. 19, 2006, which is hereby incorporated by reference herein in its entirety.

What is claimed is:

1. A moving apparatus comprising:
a movable body movable in at least one direction;
an electromagnet configured to drive a movable body and including a coil;
an electromagnet control system configured to perform feedback control of the electromagnet on a basis of a command value input to the electromagnet control system; and
a thrust correction unit configured to calculate a correction coefficient corresponding to a thrust error of the electromagnet and correct the command value by multiplying the command value by the correction coefficient or by adding the correction coefficient to the command value.

2. The moving apparatus according to claim 1, further comprising:
a sensor configured to measure a distance between the electromagnet and the movable body,
wherein the thrust correction unit calculates the correction coefficient on the basis of an output from the sensor.

3. The moving apparatus according to claim 1, further comprising:
a sensor configured to measure a thrust generated by the electromagnet,
wherein the thrust correction unit calculates the correction coefficient on the basis of an output from the sensor.

4. The moving apparatus according to claim 1, further comprising:
a linear motor configured to position the movable body,
wherein the electromagnet is driven to accelerate or decelerate the movable body.

5. An exposure apparatus comprising:
a projection optical system configured to project a pattern of an original onto a substrate; and
a moving apparatus including,
a movable body movable in at least one direction;
an electromagnet configured to drive a movable body and including a coil;
an electromagnet control system configured to perform feedback control of the electromagnet on a basis of a command value input to the electromagnet control system; and
a thrust correction unit configured to calculate a correction coefficient corresponding to a thrust error of the electromagnet and correct the command value by multiplying the command value by the correction coefficient or by adding the correction coefficient to the command value,
wherein the moving apparatus is configured to move a stage capable of holding the original or the substrate.

6. A device manufacturing method utilizing an exposure apparatus including,
a projection optical system configured to project a pattern of an original onto a substrate; and
a moving apparatus including,
a movable body movable in at least one direction;
an electromagnet configured to drive a movable body and including a coil;
an electromagnet control system configured to perform feedback control of the electromagnet on a basis of a command value input to the electromagnet control system; and
a thrust correction unit configured to calculate a correction coefficient corresponding to a thrust error of the electromagnet and correct the command value by multiplying the command value by the correction coefficient or by adding the correction coefficient to the command value,
wherein the moving apparatus is configured to move a stage capable of holding the original or the substrate;
the method comprising:
exposing a substrate using the exposure apparatus; and
developing the exposed substrate.

7. A moving apparatus comprising:
a movable body movable in at least one direction;
an electromagnet configured to drive a movable body and including a coil;
an electromagnet control system configured to perform feedback control of the electromagnet on a basis of a command value input to the electromagnet control system; and
a thrust correction unit configured to calculate a correction value corresponding to a thrust error of the electromagnet and correct the command value by the correction value.
